(19) United States
(12) Patent Application Publication
(10) Pub. No.: US 2025/0033535 A1
(43) Pub. Date: Jan. 30, 2025

(54) LOWER RAIL FOR ADJUSTING POSITION OF VEHICLE SEAT

(71) Applicants: Hyundai Motor Company, Seoul (KR); Kia Corporation, Seoul (KR); Dae Won San Up Co., Ltd., Ansan (KR)

(72) Inventors: Tae Jun Kwon, Incheon (KR); Hyun Ko, Suwon (KR); Hyun Kyu Moon, Incheon (KR); Tae Su Kim, Yongin (KR); Yeon Jin Jeon, Daegu (KR); Sang Do Park, Seoul (KR); Min Seok Kim, Hwaseong (KR); Sun Ho Hur, Seoul (KR); Tae Hyung Kim, Siheung (KR); Hyun Deok Choi, Siheung (KR)

(21) Appl. No.: 18/617,367

(22) Filed: Mar. 26, 2024

(30) Foreign Application Priority Data
Jul. 25, 2023 (KR) 10-2023-0096643

(51) Int. Cl. B60N 2/07

(52) U.S. Cl. CPC B60N 2/0715; B60N 2/0745

(57) ABSTRACT

A lower rail for a seat of a vehicle has a structure with a curved movement path, in which the seat may be moved in an oblique direction or a diagonal direction according to various seat positions, thereby allowing a degree of freedom for adjusting a seat position movement. In addition, the lower rail includes a curved inner channel bent at a predetermined angle and a curved outer channel bent at about a same angle as the curved inner channel, which are separately provided and configured to be mutually combined in order to provide one curved movement path for moving the seat.

### CROSS REFERENCE TO RELATED APPLICATION

The present application claims under 35 U.S.C. § 119 (a) the benefit of Korean Patent Application No. 10-2023-0096643, filed Jul. 25, 2023, the entire contents of which are incorporated by reference herein.

### BACKGROUND

### (a) Technical Field

The present disclosure relates to a lower rail for adjusting a position of a vehicle seat, more particularly, to the lower rail for the vehicle seat that has a curved movement path in order to provide a degree of freedom for seat position adjustment.

### (b) Description of the Related Art

In general, vehicle seats are manufactured having a structure that includes a seat cushion for supporting a passenger's lower body in a sitting position, a seat back for supporting the passenger's upper body, and a headrest for supporting the passenger's neck and head. In addition, various mechanisms are provided for adjusting seat positions according to body shape and seating position, for example.

Structural features for adjusting seat positions include a seat rail mechanism for adjusting a front and rear position of the seat, a seat height adjustment mechanism for adjusting seat height, and a seat back reclining mechanism for adjusting an angle of the seat back.

Typically, the seat rail mechanism includes a straight lower rail fixedly mounted to a floor channel in order to slide the seat forward or backward, and an upper rail inserted and fastened to be able to move forward and backward into the lower rail, where the upper rail is mounted with a seat cushion frame, which is a skeleton of the seat cushion.

Accordingly, when the upper rail slides to move in a forward or backward direction along the lower rail, the seat is also moved forward or backward together with the upper rail, so that the front and rear position of the seat may be adjusted.

However, as the above-described conventional seat rail includes a structure capable of only linear movement in a forward or backward direction, there is a disadvantage in that a degree of freedom for adjusting positional movement of the seat is reduced.

In other words, since existing seat rails may only move linearly in a forward or backward direction, when it is necessary to move the seat in an oblique direction or a diagonal direction according to various seat positions, there is a disadvantage in not being able to move the seat in such directions with existing structures.

The foregoing is intended merely to aid in the understanding of the background of the present disclosure and is not intended to mean that the present disclosure falls within the purview of the related art that is already known to those skilled in the art.

### SUMMARY

Accordingly, the present disclosure provides a lower rail for adjusting a vehicle seat, in which the lower rail has a structure with a curved movement path so that the vehicle seat may be moved in an oblique direction or a diagonal direction according to various desired seat positions, thereby providing a degree of freedom for facilitating seat position movement.

In order to achieve the above objective, according to the present disclosure, there may be provided a lower rail for a seat of a vehicle, the lower rail including: a curved inner channel bent at a predetermined angle; and a curved outer channel bent at about a same angle as the curved inner channel, wherein the inner channel and the outer channel are disposed separately and configured to be mutually combined, such that combining the inner and outer channels results in one curved movement path for moving the seat.

The inner channel and the outer channel may be bent (e.g., double-bent) at the same angle in order to provide the one curved movement path.

The curved movement path may include at least a first curved movement section and a second curved movement section.

The curved movement path may include at least one of a first straight movement section, a first curved movement section, an oblique movement section, a second curved movement section, or a second straight movement section.

Furthermore, the curved movement path may include a first straight movement section, a first curved movement section, an oblique movement section, a second curved movement section, and a second straight movement section which are continuously connected.

Specifically, the inner channel may include: a first vertical support plate; a first top plate provided to protrude in an outer direction from an upper end of the first vertical support plate; a sliding guide provided to protrude in the outer direction from a predetermined position on an inner surface of the first vertical support plate; and a first lower plate coupled to the outer channel by being bent in the outer direction from a lower end of the first vertical support plate.

A bus bar for supplying power may be inserted and mounted in a space between the first top plate and the sliding guide.

A rack gear for moving the seat may be assembled on an inner surface at a lower end of the first vertical support plate by being integrally formed or separately manufactured.

A slide bearing configured to guide movement of the seat may be mounted on the sliding guide.

The inner channel may be formed by being bent from an aluminum alloy of a soft material having a higher elongation rate compared with the outer channel.

Specifically, the outer channel may include: a second vertical support plate; a second top plate provided to protrude in an inner direction from an upper end of the second vertical support plate; and a second lower plate coupled to the inner channel by being bent in the inner direction from a lower end of the second vertical support plate.

A space between the second top plate and the second lower plate may be provided as a roller insertion space into which a roller for moving the seat is inserted.

The outer channel may be formed by being bent from an aluminum alloy of a highly strong material having higher strength compared with the inner channel.

Meanwhile, the lower rail composed of the inner channels and the outer channels, which are respectively coupled to each other, may include a first lower rail and a second lower rail connected by a connection bracket.

The connection bracket may be provided in a structure capable of keeping a width between the first lower rail and the second lower rail constant.

To this end, the connection bracket may include: a first mounting plate and a second mounting plate mounted on outer bottoms of the first lower rail and the second lower rail, respectively; and a bridge part integrally connecting a gap between the first mounting plate and the second mounting plate and bent upward, thereby being arranged to be in parallel with top surfaces of the first lower rail and the second lower rail.

In addition, over a top surface of the bridge part, the top surface of the first lower rail, and the top surface of the second lower rail, a cover for blocking foreign substances may be attached so as to minimize foreign substances penetrating into a space between the inner channel and the outer channel of each of the first lower rail and the second lower rail.

A vehicle may include the above-described lower rail.

As described above, through the above-described means for solving the problem, the present disclosure provides effects in the following.

First, a lower rail for a seat is improved into a structure having a curved movement path, whereby the seat can be moved in an oblique direction or a diagonal direction according to various seat positions, thereby allowing a degree of freedom for adjusting a seat position movement.

Second, in consideration of the fact that a seat belt anchorage load, a passenger load acting on the seat belt during a collision, and the like act on the outer channel, the outer channel can be formed by being bent from an aluminum alloy of a highly strong material that has higher strength compared with the inner channel, thereby allowing securing high strength and preventing deformation of the outer channel to be accomplished.

Third, in consideration of the fact that the inner channel is provided in a more complex structure such as having a sliding guide, a rack gear, and the like compared with the outer channel, the inner channel can be applied with an aluminum alloy of high-softness of a soft material that has a higher elongation rate compared with the outer channel, thereby allowing bending and forming of the inner channel to be easily accomplished and the dimensional accuracy of the inner channel to be satisfied.

Fourth, the first lower rail and the second lower rail can be connected by a connection bracket provided in a structure capable of keeping a width of a gap constant while absorbing a tolerance.

Fifth, a busbar for supplying power can be mounted in the inner channel of the lower rail, whereby the battery power can be supplied to the motor for moving the seat through the busbar for power supply.

Sixth, a cover for blocking foreign substances can be attached over upper surfaces of the first lower rail, a bridge part, and the second lower rail, thereby minimizing foreign substances penetrating into a space between the inner channel and the outer channel.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view showing a lower rail for a seat of a vehicle according to the present disclosure;

FIG. 2 is a sectional view showing the lower rail for a seat of a vehicle according to the present disclosure;

FIG. 3 is a perspective view showing a state in which a first lower rail and a second lower rail for the seat of a vehicle according to the present disclosure are connected by a connecting bracket;

FIG. 4 is a sectional view showing the state in which the first lower rail and the second lower rail for the seat of a vehicle according to the present disclosure are connected by the connecting bracket;

FIG. 5 is a perspective view showing a state in which a cover for blocking foreign substances is attached to the lower rail for a seat of a vehicle according to the present disclosure;

FIG. 6 is a sectional view showing the state in which the cover for blocking foreign substances is attached to the lower rail for a seat of a vehicle according to the present disclosure;

FIGS. 7, 8, and 9 are sectional views each showing a coupling method between an inner channel and an outer channel constituting the lower rail for a seat of a vehicle according to the present disclosure;

FIG. 10 is a perspective view showing a state in which an upper rail is coupled to be slidingly movable to the lower rail for a seat of a vehicle according to the present disclosure; and

FIG. 11 is a sectional view showing the state in which the upper rail is coupled to be slidingly movable to the lower rail for a seat of a vehicle according to the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Specific structural and functional descriptions described in the embodiments of the present specification are merely exemplified for the purpose of explaining embodiments according to a concept of the present disclosure, and the embodiments according to the concept of the present disclosure may be implemented in various forms. In addition, the disclosure should not be construed to be limited by the embodiments described in the present specification and should be understood to include all modifications, equivalents, or substitutes included in the spirit and technical scope thereof.

Meanwhile, in the present disclosure, terms such as first and/or second may be used to describe various components, but the components are not limited by the terms. The above terms are used only for the purpose of distinguishing one component from other components, and for example, within a range not departing from the scope of rights according to the concept of the present disclosure, a first component may be referred to as a second component, and similarly, the second component may also be referred to as the first component.

It should be understood that when a component is referred to as being “coupled” or “connected” to another component, it may be directly coupled or connected to another component, but other components may even exist in the middle. On the other hand, when a component is referred to as being “directly coupled” or “directly connected” to another component, it should be understood that no other component exists in the middle. Other expressions used to describe the relationship between each component, such as “between” and “directly between” or “adjacent to” and “directly adjacent to”, should be interpreted similarly.

Like reference numbers indicate like elements throughout the specification. Terms used in the present specification are for describing the embodiments and are not intended to limit the present disclosure. In the present specification, a singular form also includes a plural form unless specifically stated in a phrase.

Hereinbelow, exemplary embodiments of the present disclosure will be described in detail with reference to the accompanying drawings.

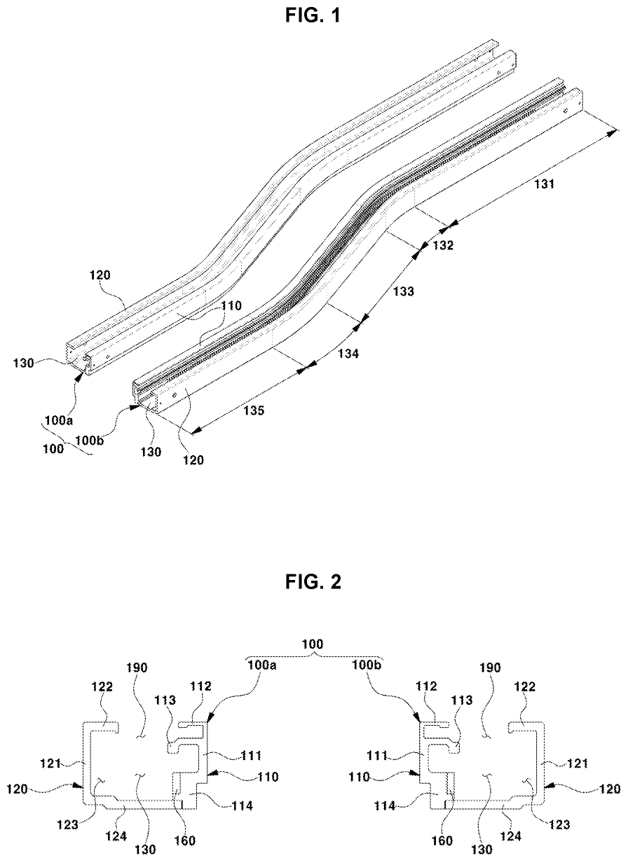

FIGS. 1 and 2 show a lower rail for a seat of a vehicle according to the present disclosure.

As shown in FIGS. 1 and 2, the lower rail 100 according to the present disclosure includes a first lower rail 100a and a second lower rail 100b manufactured in the same structure.

In particular, the first lower rail 100a and the second lower rail 100b of the lower rail 100 respectively include a curved inner channel 110 and a curved outer channel 120 that are separately manufactured.

That is, after an inner channel 110 and an outer channel 120 are each manufactured in a double-bent structure at about a same angle in order to provide one curved movement path 130, the first lower rail 100a and the second lower rail 100b of the lower rail 100 may each be provided in a structure that the inner channel 110 and outer channel 120 manufactured separately are mutually bonded.

More specifically, after the curved inner channel 110 bent at a predetermined angle and the curved outer channel 120 bent at about the same angle as the curved inner channel 110 are separately manufactured, the first lower rail 100a and the second lower rail 100b of the lower rail 100 may each be provided in the structure that the inner channel 110 and the outer channel 120 separately manufactured are mutually combined in order to provide one curved movement path 130 for moving the seat.

As described above, the inner channel 110 and the outer channel 120 are each manufactured in a bent structure (e.g., a double-bent structure) at about the same angle and then mutually coupled, whereby one curved movement path 130 inside the inner channel 110 and the outer channel 120 may be provided.

Here, the curved movement path 130 may be provided in a shape including a first straight movement section 131, a first curved movement section 132, an oblique movement section 133, a second curved movement section 134, and a second straight movement section 135, which are continuously connected to be able to communicate.

As shown in FIG. 2, the inner channel 110 includes a first vertical support plate 111, a first top plate 112 provided to protrude in an outer direction from the upper end of the first vertical support plate 111, a sliding guide 113 protruding in the outer direction from a predetermined position on an inner surface of the first vertical support plate 111 and guiding the movement of the seat along the curved movement path 130; and a first lower plate 114 bent in the outer direction from a lower end of the first vertical support plate 111 and coupled to the outer channel 120.

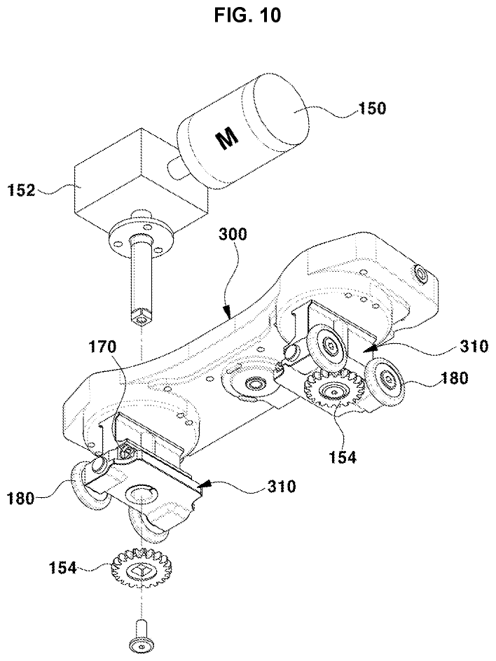

In addition, a busbar 140 for supplying power is inserted and mounted in the space between the first top plate 112 and the sliding guide 113 of the inner channel 110, and the busbar 140 for supplying power serves to supply power to the motor (indicated by 150 in FIG. 10) for forward and backward movement of the seat.

For example, the busbar 140 for supplying power is connected to be able to conduct to the battery supplying power by the wiring and the like and is connected to be able to conduct to the motor by the wiring and the like, thereby playing a role of transmitting power provided from the battery power supply to the motor 150.

In addition, the rack gear 160 for moving the seat is integrally formed or separately manufactured and assembled on a lower inner surface of the first vertical support plate 111 of the inner channel 110.

In other words, the rack gear 160 may be integrally formed on the lower inner surface of the first vertical support plate 111 when forming the inner channel 110 is formed to manufacture. Alternatively, the rack gear 160 may be separately manufactured and assembled by the medium of bolts or the like to the lower inner surface of the first vertical support plate 111.

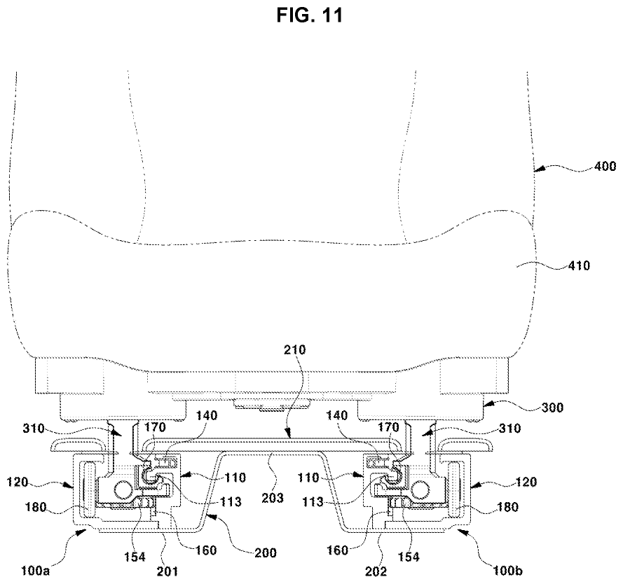

At this time, as shown in FIGS. 10 and 11, a pinion 154 rotated by driving of the motor 150 becomes to be engaged with the rack gear 160.

In addition, a slide bearing 170 for guiding the movement of the seat along the curved movement path 130 may be inserted and mounted in the sliding guide 113 of the inner channel 110.

In particular, in consideration of the fact that the inner channel 110 is provided in a more complex structure such as having a sliding guide 113, a rack gear 160, and the like compared with the outer channel 120, the inner channel 110 may be formed by being bent with an aluminum alloy (for example, AL60 series) of high softness of a soft material that has a higher elongation rate compared with the outer channel 120, thereby allowing bending and forming of the inner channel 110 to be easily accomplished and the dimensional accuracy of the inner channel 110 to be satisfied.

As shown in FIGS. 1 and 2, the outer channel 120 may include a second vertical support plate 121, a second top plate 122 protruding inward from an upper end of the second vertical support plate 121, and a second lower plate 124 coupled to the inner channel 110 by being bent in an inner direction from a lower end of the second vertical support plate 121.

At this time, a space between the second upper plate 122 and the second lower plate 124 of the outer channel 120 is provided as a roller insertion space 123 into which a roller 180 for moving the seat is inserted.

In particular, in consideration of the fact that a seat belt anchorage load, a passenger load acting on the seat belt during a collision, and the like intensively act on the outer channel 120, the outer channel 120 may be formed by being bent from an aluminum alloy (for example, AL70 series) of a highly strong material that has higher strength compared with the inner channel 110, thereby allowing securing the high strength and preventing deformation, of the outer channel 120, to be accomplished.

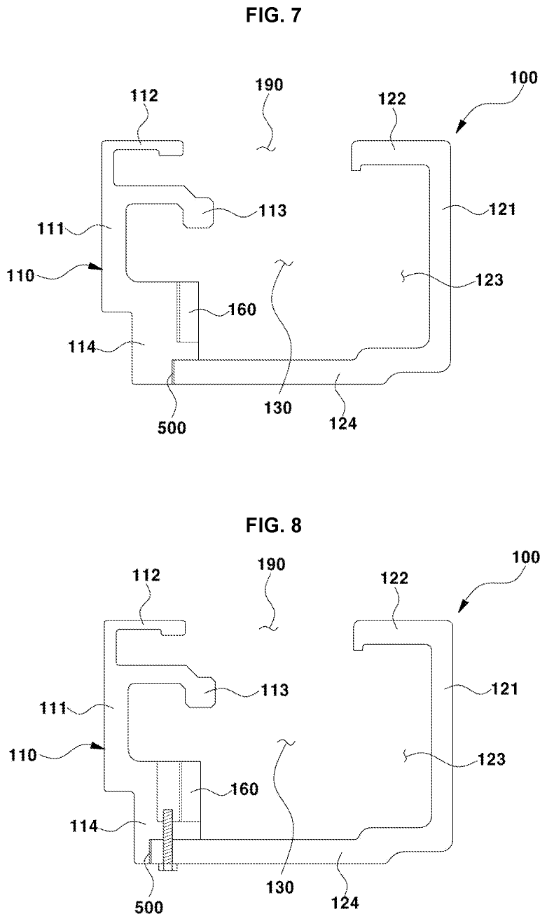

On the other hand, when the rack gear 160 is integrally formed to the first vertical support plate 111 of the inner channel 110, as shown in FIG. 7, in a state in which the first lower plate 114 of the inner channel 110 and the second lower plate 124 of the outer channel 120 are brought into close contact with each other, friction stir welding 500 is implemented, thereby allowing the inner channel 110 and the outer channel 120 to be combined while providing one curved movement path 130.

Alternatively, when the rack gear 160 is manufactured into a separate object, as shown in FIG. 8, in a state in which the rack gear 160 is brought into close contact with an inner surface of the first lower plate 114 of the inner channel 110, the rack gear 160, the first lower plate 114 of the inner channel 110, and the second lower plate 124 of the outer channel 120 may be coupled by the medium of a bolt or the like, thereby allowing the inner channel 110 and the outer channel 120 to be combined while providing one curved movement path 130.

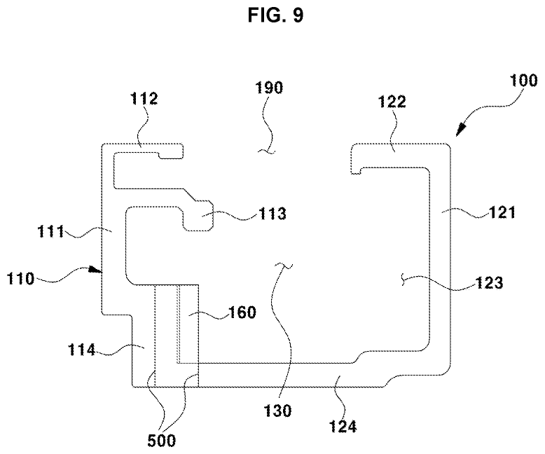

Alternatively, when the rack gear 160 is manufactured into a separate object, as shown in FIG. 9, in a state in which the rack gear 160 is disposed and brought into close contact between the first lower plate 114 of the inner channel 110 and the second lower plate 124 of the outer channel 120, friction stir welding 500 is implemented between the rack gear 160 and the first lower plate 114 and friction stir welding 500 is implemented between the rack gear 160 and the second lower plate 124, thereby allowing the inner channel 110 and the outer channel 120 to be combined while providing one curved movement path 130.

At this time, the first top plate 112 of the inner channel 110 and the second top plate 122 of the outer channel 120 provide an opening 190 and are disposed to be spaced apart from each other, whereby, as to be described later, the slider combined with the upper rail may move along the opening 190 and the curved movement path 130.

In this way, the inner channel 110 and the outer channel 120 are mutually coupled while providing one curved movement path 130, whereby the lower rail 100 including the first lower rail 100a and the second lower rail 100b may be completed.

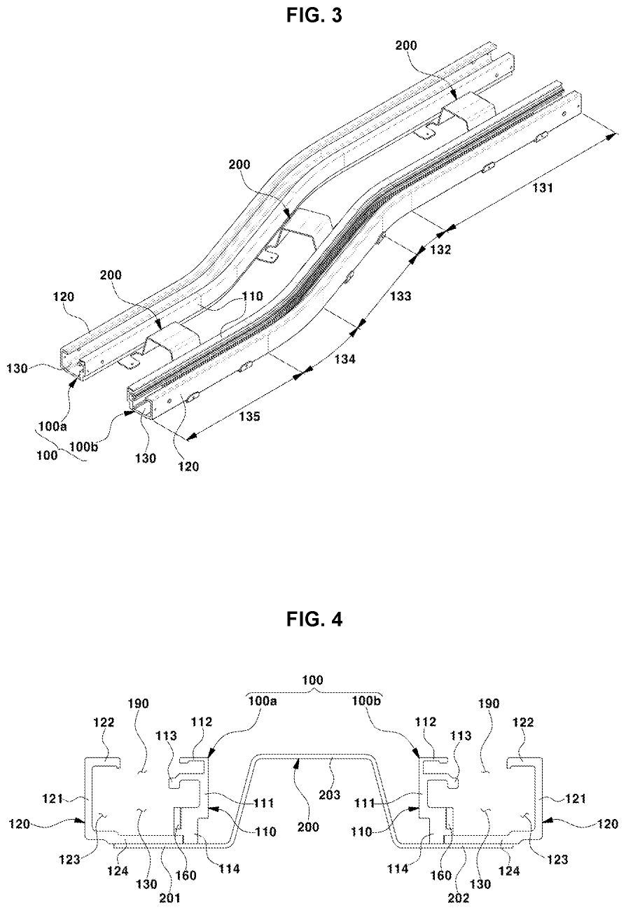

On the other hand, as shown in FIGS. 3 and 4, the first lower rail 100a and the second lower rail 100b may be connected by a connection bracket 200, wherein the connection bracket 200 is provided in a structure capable of keeping a width of a gap constant while absorbing a tolerance.

More specifically, as shown in FIGS. 3 and 4, the connection bracket 200 includes: a first mounting plate 201 and a second mounting plate 202 mounted on the bottoms of the first lower rail 100a and the second lower rail 100b, respectively; and a bridge part 203 integrally connecting the first mounting plate 201 and the second mounting plate 202 and arranged and upward, thereby being arranged while being maintained to be in parallel with top surfaces of the first lower rail 100a and the second lower rail 100b.

Accordingly, after being connected by the connecting bracket 200, the first lower rail 100a and the second lower rail 100b may be fixedly mounted on a floor panel of the vehicle.

Meanwhile, as the opening 190 is provided between the first top plate 112 of the inner channel 110 and the second top plate 122 of the outer channel 120 wherein the inner channel 110 and the outer channel 120 constitute each of the first lower rail 100a and the second lower rail 100b, foreign substances that act as an obstacle to seat movement control may permeate into the curved movement path 130 through the opening 190.

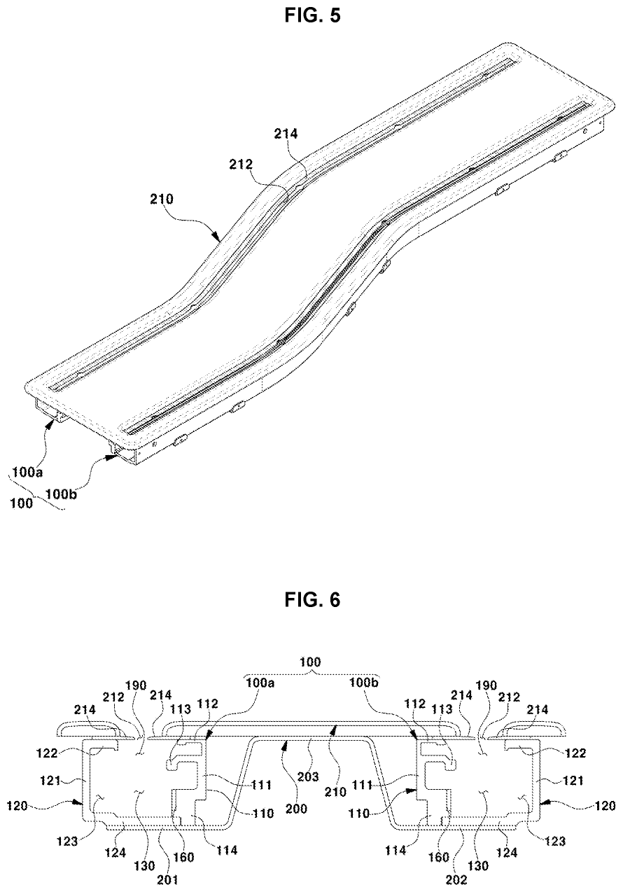

To solve this, as shown in FIGS. 5 and 6, over an upper surface of the bridge part 203 of the connection bracket 200, the upper surface of the first lower rail 100a, and the upper surface of the second lower rail 100b, a cover 210 for blocking foreign substances may be attached so as to minimize foreign substances penetrating into the space between the inner channel 110 and the outer channel 120, that is, into an inner space of the curved movement path 130.

Of the total area of the cover 210 for blocking foreign substances, each of portions covering the openings 190 is provided with a flexible sealing wing 214 having a long incision hole 212, and as will be described later, when a slider 310 of an upper rail 300 moves along the opening 190 and the curved movement path 130, the sealing wing 214 serves as a seal to block foreign substances while being brought into contact with the slider 310.

Here, a structure in which the upper rail is movably assembled to the lower rail provided with the above structure is looked at as follows.

FIGS. 10 and 11 show a state in which the upper rail is coupled to be slidingly movable to the lower rail for a seat of a vehicle according to the present disclosure.

As shown in FIGS. 10 and 11, a seat cushion 410 of the seat 400 is coupled to an upper part of the upper rail 300, and the slider 310 is integrally connected to a lower part of the upper rail 300.

In particular, the slider 310 is movably inserted into and fastened to a space between the inner channel 110 and the outer channel 120, that is, the inner space of the curved movement path 130.

To this end, the roller 180 for moving the seat is rotatably fastened to an outer surface of the slider 310, thereby being disposed in the roller insertion space 123 between the second upper plate 122 and the second lower plate 124 of the outer channel 120.

In addition, the slide bearing 170 is mounted on an inner surface of the slider 310, and the sliding guide 113 of the inner channel 110 is inserted into and fastened to the slide bearing 170.

In addition, as shown in FIG. 11, a pinion 154 meshes with the rack gear 160 provided in the inner channel 110, wherein the pinion 154 may be rotatably connected to an output part of the gearbox 152 connected to the motor 150.

At this time, the battery power may be supplied to the motor 150 through the busbar 140 for power supply.

Therefore, when a rotational force according to driving of the motor 150 is transmitted to the pinion 154 through the gear box 152, the pinion 154 may move forward or backward along the rack gear 160. As the pinion 154 moves, the slider 310, the upper rail 300 integrated with the slider 310, and the seat 400 mounted on the upper rail 300 may move forward or backward.

In particular, the slider 310 is configured to sequentially go by the first linear movement section 131, first curve movement section 132, oblique movement section 133, second curve movement section 134, and the second linear movement section 135 of the curved movement path 130 which is provided by the inner channel 110 and the outer channel 120, so the seat may be moved in an oblique direction or a diagonal direction according to various seat positions, and a degree of freedom for adjusting the movement of the seat position may be improved accordingly.

Although the present disclosure has been described in detail with various embodiments above, the scope of the present disclosure is not limited to the above-described embodiments, and it should be understood that various modifications and improvements of those skilled in the art using the basic concept of the present disclosure defined in the following claims will also be included in the scope of the right of the present disclosure.

What is claimed is:

1. A lower rail for a seat of a vehicle, the lower rail comprising:
a curved inner channel bent at a predetermined angle; and
a curved outer channel bent at about a same angle as the curved inner channel,
wherein the inner channel and the outer channel are disposed separately and configured to be mutually combined, such that combining the inner and outer channels results in one curved movement path for moving the seat.

2. The lower rail of claim 1, wherein the inner channel and the outer channel are bent at the same angle in order to provide the one curved movement path.

3. The lower rail of claim 2, wherein the inner channel and the outer channel are double-bent at the same angle.

4. The lower rail of claim 2, wherein the curved movement path comprises at least a first curved movement section and a second curved movement section.

5. The lower rail of claim 2, wherein the curved movement path includes at least one of a first straight movement section, a first curved movement section, an oblique movement section, a second curved movement section, or a second straight movement section.

6. The lower rail of claim 2, wherein the curved movement path comprises a first straight movement section, a first curved movement section, an oblique movement section, a second curved movement section, and a second straight movement section which are continuously connected.

7. The lower rail of claim 1, wherein the inner channel comprises:
a first vertical support plate;
a first top plate provided to protrude in an outer direction from an upper end of the first vertical support plate;
a sliding guide provided to protrude in the outer direction from a predetermined position on an inner surface of the first vertical support plate; and
a first lower plate coupled to the outer channel by being bent in the outer direction from a lower end of the first vertical support plate.

8. The lower rail of claim 7, wherein a busbar for supplying power is inserted and mounted in a space between the first top plate and the sliding guide.

9. The lower rail of claim 7, wherein a rack gear for moving the seat is assembled on an inner surface at a lower end of the first vertical support plate by being integrally formed or separately manufactured.

10. The lower rail of claim 7, wherein a slide bearing configured to guide movement of the seat is mounted on the sliding guide.

11. The lower rail of claim 7, wherein the inner channel is formed by being bent from an aluminum alloy of a soft material having a higher elongation rate compared with the outer channel.

12. The lower rail of claim 1, wherein the outer channel comprises:
a second vertical support plate;
a second top plate provided to protrude in an inner direction from an upper end of the second vertical support plate; and
a second lower plate coupled to the inner channel by being bent in the inner direction from a lower end of the second vertical support plate.

13. The lower rail of claim 12, wherein a space between the second top plate and the second lower plate is provided as a roller insertion space into which a roller for moving the seat is inserted.

14. The lower rail of claim 12, wherein the outer channel is formed by being bent from an aluminum alloy of a highly strong material having higher strength compared with the inner channel.

15. The lower rail of claim 1, wherein the lower rail comprises the inner channels and the outer channels, which are respectively coupled to each other.

16. The lower rail of claim 15, wherein the lower rail further comprises:
a first lower rail and a second lower rail connected by a connection bracket.

17. The lower rail of claim 16, wherein the connection bracket is provided in a structure capable of keeping a width between the first lower rail and the second lower rail constant.

18. The lower rail of claim 17, wherein the connection bracket comprises:
a first mounting plate and a second mounting plate mounted on outer bottoms of the first lower rail and the second lower rail, respectively; and
a bridge part integrally connecting a gap between the first mounting plate and the second mounting plate and bent upward, thereby being arranged to be in parallel with top surfaces of the first lower rail and the second lower rail.

19. The lower rail of claim 18, further comprising a cover for blocking foreign substances, the cover being attached over a top surface of the bridge part, the top surface of the first lower rail, and the top surface of the second lower rail, the cover configured to minimize the foreign substances penetrating into a space between the inner channel and the outer channel of each of the first lower rail and the second lower rail.

20. A vehicle comprising the lower rail of claim 1.
